(19) United States
(12) Patent Application Publication
(10) Pub. No.: US 2026/0214775 A1
(43) Pub. Date: Jul. 23, 2026

(54) DYNAMIC CAR WASH LIGHTING SYSTEM

(71) Applicant: WASH GEC INC, DENVER, NC (US)

(72) Inventors: Jason Cunningham, Mission Hills, KS (US); Kole Greffin, Denver, NC (US); Jeffrey Resmer, Park Ridge, IL (US)

(73) Assignee: WASH GEC INC, DENVER, NC (US)

(21) Appl. No.: 19/413,706

(22) Filed: Dec. 9, 2025

Related U.S. Application Data
(60) Provisional application No. 63/748,209, filed on Jan. 22, 2025.

(51) Int. Cl. H05B 47/175

(52) U.S. Cl. CPC H05B 47/196

(57) ABSTRACT

A controller system and method allow for color, timing, and other settings for individual lights to form one or more routines within a car wash environment. The controller system includes a graphical user interface (GUI) having drag-and-drop functionality for adding individual lighting fixtures and/or structures to a digital twin of the car wash, allowing for simulation of a lighting routine to visualize how the routine will function over the course of a typical wash.

### CROSS-REFERENCE TO RELATED APPLICATIONS

This application is related to and claims priority from the following US patents and patent applications: this application claims priority from and the benefit of U.S. Provisional Ser. No. 63/748,209 , filed Jan. 22, 2025, which is incorporated herein by reference in its entirety.

### BACKGROUND OF THE INVENTION

### 1. Field of the Invention

The present invention relates to systems and methods for dynamic light management, and more specifically to systems for managing a car wash lighting system.

### 2. Description of the Prior Art

It is generally known in the prior art to provide dynamic lighting systems for events such as concerts.

Prior art patent documents include the following:
US Patent Pub. No. 2023/0239989 for Method and System for Changing a Function of a Lighting Device by inventors Baright et al., filed Mar. 29, 2023 and published Jul. 27, 2023, discloses lighting devices and, more particularly, a method and system for changing a function of a lighting device. In one embodiment, the invention provides a system comprising: at least one lighting device; an audio source; a controller for synchronizing an audio signal from the audio source with a lighting signal delivered to the at least one lighting device; and a transmitter for transmitting the audio signal from the audio source to at least one external receiver.
U.S. Pat. No. 10,696,278 for Lighted vehicle wash dryer assembly control system by inventor Belanger, filed Mar. 11, 2016 and issued Jun. 30, 2020, discloses a vehicle wash system having an entrance end, an exit end, and a vehicle treatment area. The system including a dryer element disposed on a frame adjacent the exit end. The dryer element includes an air inlet, a plurality of air outlets, and a housing constructed of a translucent material. The dryer element includes light source disposed in the housing and configured to emit light in a plurality of different colors. The light source has a plurality of modes each corresponding to a different system condition. The system also includes a controller in communication with the light source and configured to enable the plurality of modes in response to a detected system condition.
U.S. Pat. No. 10,391,982 for Lighted vehicle wash conveyor assembly by inventors Belanger et al., filed Apr. 7, 2017 and issued Aug. 27, 2019, discloses a lighted conveyor assembly for a vehicle wash system for moving a vehicle through a vehicle wash process including a vehicle treatment area and including a pair of guide rails for engaging the wheels of the vehicle to keep it on the conveyor. The guide rails including a protective sheath disposed thereon for preventing damage to the wheels of the vehicle. The protective sheath is made of a translucent material and contains a light source, which may be an LED strip light, and is configured to emit light that can be seen by a vehicle occupant in the vehicle treatment area. The light source may display a variety of patterns or effects, including specific colors or patterns to indicate that associated features of the car wash process are active. The light source may also be seen from outside of the treatment area to provide a positive impression for potential customers.

U.S. Pat. No. 11,007,983 for Active site marketing vehicle wash system by inventors Belanger et al., filed Mar. 7, 2019 and issued May 18, 2021, discloses a vehicle wash system disposed in a vehicle wash facility including a plurality of vehicle wash components disposed adjacent a vehicle treatment area. The system includes plurality of lights to be disposed in the vehicle wash facility. Each of the lights is configured with at least a first state and in communication with a controller. The controller is configured to enable the first state of the plurality of lights when no vehicles are present in the vehicle wash facility. When the first state is enabled, the plurality of lights are configured to emit light in a preprogrammed pattern of different colors.

U.S. Pat. No. 9,427,765 for Tank system for producing bubbles and illuminating the bubbles as they fall from the tank onto a passing vehicle by inventor Ennis, filed Aug. 12, 2013 and issued Aug. 30, 2016, discloses a tank system for dropping fluid onto a passing vehicle. The tank system includes a tank with a fluid supply inlet. Optionally, a soap injector is included for injecting soap into the water flow to create a fluid mix that is supplied to the tank. A lighting system is attached to the tank. The fluid mix, or any other chemical in the tank, may be heated with the heating unit. An air motor is included for providing air to an air manifold that is disposed within the tank. When air is introduced into the fluid mix, bubbles are created. As the fluid mix and bubbles fill the tank, they fall from the tank via an overflow lip, with the fluid mix and/or bubbles being illuminated by the lighting system as they fall onto a vehicle passing below.

### SUMMARY OF THE INVENTION

The present invention relates to systems and methods or dynamic light management, and more specifically to systems for managing a car wash lighting system.

It is an object of this invention to provide an easy-to-manage interface for programming different dynamic lighting routines for a car wash, including drag-and-drop capabilities and click-to-edit settings for each individual lighting device.

In one embodiment, the present invention is directed to a system for managing dynamic lighting for a car wash, including a server platform, including a processor and a memory, and a graphical user interface (GUI) generated on a user device in network communication with the server platform, wherein the GUI includes a digital twin of a car wash system, and wherein the GUI is configured to receive drag and drop selection of one or more digital twins of programmable light elements on the car wash system.

In another embodiment, the present invention is directed to a method for managing dynamic lighting for a car wash, including providing a server platform, including a processor and a memory, and generating a graphical user interface (GUI) on a user device in network communication with the server platform, the GUI displaying a digital twin of a car wash system, and the GUI receiving drag and drop selection of one or more digital twins of programmable light elements on the car wash system.

In yet another embodiment, the present invention is directed to a system for managing dynamic lighting for a car wash, including a server platform, including a processor and a memory, and a graphical user interface (GUI) generated on a user device in network communication with the server platform, wherein the GUI includes a digital twin of a car wash system, wherein the GUI is configured to receive selection of settings for one or more digital twins of programmable light elements on the car wash system, and wherein actual light elements corresponding to the one or more digital twins are automatically programmed in accordance with the selection of the settings.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a graphical user interface (GUI) of a software application including a model of a car wash system with programmable lighting installments according to one embodiment of the present invention.

FIG. 2 illustrates a lighting configuration settings window of a GUI according to one embodiment of the present invention.

FIG. 3 illustrates an action run window of a GUI according to one embodiment of the present invention.

FIG. 4 illustrates an input-output configuration window of a GUI according to one embodiment of the present invention.

FIG. 5 illustrates a lighting device settings window of a GUI according to one embodiment of the present invention.

FIG. 6 illustrates a device management page of a GUI according to one embodiment of the present invention.

FIG. 7 illustrates an action configuration window of a GUI according to one embodiment of the present invention.

FIG. 8 is a schematic diagram of a system of the present invention.

### DETAILED DESCRIPTION

The present invention is generally directed to systems and methods or dynamic light management, and more specifically to systems for managing a car wash lighting system.

In one embodiment, the present invention is directed to a system for managing dynamic lighting for a car wash, including a server platform, including a processor and a memory, and a graphical user interface (GUI) generated on a user device in network communication with the server platform, wherein the GUI includes a digital twin of a car wash system, and wherein the GUI is configured to receive drag and drop selection of one or more digital twins of programmable light elements on the car wash system.

In another embodiment, the present invention is directed to a method for managing dynamic lighting for a car wash, including providing a server platform, including a processor and a memory, and generating a graphical user interface (GUI) on a user device in network communication with the server platform, the GUI displaying a digital twin of a car wash system, and the GUI receiving drag and drop selection of one or more digital twins of programmable light elements on the car wash system.

In yet another embodiment, the present invention is directed to a system for managing dynamic lighting for a car wash, including a server platform, including a processor and a memory, and a graphical user interface (GUI) generated on a user device in network communication with the server platform, wherein the GUI includes a digital twin of a car wash system, wherein the GUI is configured to receive selection of settings for one or more digital twins of programmable light elements on the car wash system, and wherein actual light elements corresponding to the one or more digital twins are automatically programmed in accordance with the selection of the settings.

Given the number of car washes, the task of standing out against competitors is both difficult and extremely important. One way of standing out is to provide a more entertaining and engaging wash for customers. As automated car washes generally involve the car passing through a low lighting tunnel, the experience is well-suited to improvement by means of enhancing the lighting within the dim light of the tunnel. Some companies, such as G&G INDUSTRIAL LIGHTING, through its COLORWASH system, have introduced programmable DMX-based lighting, providing for the ability to set specific routines and lighting programs in the context of car washes.

However, while systems such as COLORWASH provide for the ability to implement custom routines, the user interface (UI) for creating such custom routines needs improvement. In particular, the ability to more easily place lights or other elements within a digital twin environment simulating the car wash would provide a particular improvement in the ability of a car wash operator to visualize a routine before implementing it and to iterate minor changes to the routine to best embody the creative visions of the routine creator. Furthermore, there is a need for a system that allows for more customizable routines, rather than simple reliance on preset shows. Existing systems, such as COLORWASH, for example, do not provide for a digital twin visualizing the show, instead providing a table of lights, allowing for selection of one or more colors and one or more preset “shows” for the lights, where the shows provide a pattern of the selected colors or select blink timings, or other such parameters. Therefore, a system is needed that provides for greater customizability and predictability of car wash lighting routines.

Referring now to the drawings in general, the illustrations are for the purpose of describing one or more preferred embodiments of the invention and are not intended to limit the invention thereto.

The system of the present invention includes a platform, including a processor and a memory, for visualizing and managing lighting routines for a car wash system, as well as a lighting control module configured to connect with one or more different lights to execute a lighting routine for the car wash. Importantly, the system of the present invention is not limited to only managing lights within the interior of a car wash system, but is also capable of controlling external lighting of the structure, as well as other lighting areas either as part of a single routine, or as separate lighting routines.

The present invention is able of onboarding, programming, and controlling DMX-512 compliant lighting modules, as well as other non-DMX lighting. This is advantageous, as it allows for operation of the system without replacing each of the lighting implements for DMX-512 compliant lighting. In one embodiment, the lighting fixtures used for the routines created and controlled using the present invention include light bulbs, light strips, and/or other lighting fixture form factors, including both monocolored and multicolored lighting devices.

The platform of the present invention is able to be used to create routines to update the lighting control module in actually controlling a lighting routine, or is able to be used as an independent visualization tool to preview the effect of the routine and/or to fine-tune the routine to provide an optimal effect. In one embodiment, the lighting control module only is able to effect a single routine at a given time and is able to be updated (either by the platform or manually by an operator) to change the routine. In another embodiment, the lighting control module is able to have multiple routines selected at once and is able to receive selection of a particular routine to implement during a particular wash. For example, in one embodiment, a user device operated by a customer of a car wash is able to pick a particular theme, type of show, or wash type, with the lighting control module receiving this selection, directly or indirectly via an intermediary device, and implementing a routine corresponding to the selection of the user device.

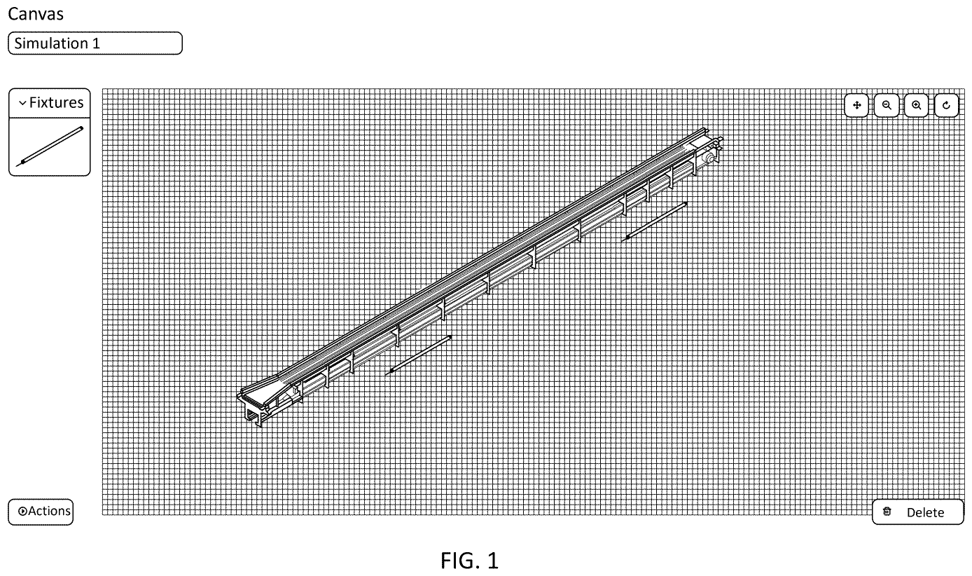

FIG. 1 illustrates a graphical user interface (GUI) of a software application including a model of a car wash system with programmable lighting installments according to one embodiment of the present invention. The system of the present invention includes a GUI wherein a lighting routine is able to be created using a digital twin of a car wash system. Routines generated using the digital twin of the GUI are able to be provided to a controller connected to actual lighting fixtures within the car wash, where the controller automatically implements the routines of the digital twin by activating and/or adjusting the actual lighting fixtures accordingly.

In one embodiment, in order to generate the digital twin of the car wash system, the platform receives an initial input from a user device (e.g., a computer, a tablet, a smart phone, etc.) of one or more initial parameters for the car wash system. In one embodiment, initial parameters include a length of the car wash system (e.g., 50 m, 100 m, etc.), a type of car wash system, a speed at which cars are preset to move through the car wash system, one or more structural elements of the car wash system, a photo eye position within the car wash system, any elevation changes within the car wash system, any deviations of the car wash system from a straight line path, and/or one or more other parameters. In one embodiment, the photo eye position is the distance from the beginning of the car wash system conveyor to the first light added to the digital twin. For example, based on a received input of a length of a car wash system, the scale of the generated digital twin changes, and therefore changes relative to individual fixtures being added. Preset speeds for the movement of vehicles through the system is able to influence light timings, in the event that light timings have settings based on the position and/or state of the vehicle. In the event that the car wash system includes deviations from a straight path or includes elevation changes, the geometry of the digital twin is able to change accordingly such that the digital twin accurately reflects the shape of the car wash system.

In one embodiment, one or more of the initial parameters are provided via upload of one or more computer-aided design (CAD) files and/or any other virtual model of the car wash system such that the digital twin generated by the platform accurately reflects the shape, size, and/or physical features of the car wash system such that the most accurate lighting routine is able to be created. In one embodiment, one or more of the initial parameters are provided via text input into a text box. In one embodiment, the platform includes an input module configured to receive natural language input describing components or properties of the car wash system, with the input module including at least one machine learning model (e.g., a natural language processing model) configured to interpret the natural language input to determine one or more properties of the system, which are then imparted to the digital twin constructed by the system.

In addition to the one or more initial parameters of the car wash system, in one embodiment, the platform receives from the user device or automatically designates, one or more file parameters for the simulation, including, but not limited to, a name, a firmware version, a software version, a date on which the simulation was originally created, a date when the simulation was last updated, a user profile that created the simulation, a user profile that last edited the simulation, and/or one or more other file parameters.

FIG. 1 shows a page of the GUI, showing the constructed digital twin of the car wash system. In one embodiment, the page includes information regarding the simulation file, such as a name of the file, a last saved time or date for the file, a creator of the file, and/or other information. In one embodiment, the page includes buttons for zooming into and zooming out of the simulation to allow for more fine-tuned editing of the digital twin and lighting routine, which is especially useful for simulations with large numbers of fixtures. In one embodiment, the page includes one or more buttons for automatically adjusting the zoom to a level at which all fixtures and components on the digital twin are visible. In one embodiment, the page includes a refresh button, which is able to stop any currently running simulations and reset any moving components to an initial position. In one embodiment, the page includes a button for exporting the digital twin as a file (e.g., a JSON file). In one embodiment, the page includes a button for deleting the simulation.

Importantly, in one embodiment, the page includes a list of one or more lighting fixtures and/or one or more structural elements able to be dragged and dropped via a user device onto the digital twin. This allows for a user to easily place fixtures and structural elements at a position along the car wash system that accurately reflects both the actual physical configuration of the car wash system and the creative vision of the user. In one embodiment, the list of one or more lighting fixtures and/or one or more structural elements is a collapsible drop down list, able to be scrolled to find particular fixtures or structures. In one embodiment, the list includes one or more categories of types of fixtures and/or structures to allow a user to more easily find what fixtures are to be used.

Fixtures on the list of fixtures able to be added include a physical model and a set of parameters able to be set for the fixture by a user device. This is important in ensuring both that fixtures have all the appropriate settable parameters and that the fixtures do not appear to have additional settable parameters that they are, in fact, not capable of varying. For example, for a given fixture, in addition to the model (including the size and shape of the device), the fixture includes a list of colors able to be displayed, a number of colors able to be displayed simultaneously (as well as which colors are able to be displayed simultaneously), minimum and maximum timing settings, maximum or minimum output brightness, and/or other parameters. In one embodiment, after the fixtures are dragged and dropped into the digital twin model, the fixtures are able to be rotated in two dimensions. In one embodiment, after the fixtures are dragged and dropped into the digital twin model, the fixtures are able to be rotated in three dimensions. In one embodiment, the platform includes a “snap to” feature for the fixtures being dragged, such that the fixtures snap to particular structures or areas of structures of existing components of the system for ease of organization. In one embodiment, the platform does not include a “snap to” feature, while, in another embodiment, the “snap to” is able to be toggled on or off, or is only available for particular types of fixtures or structures.

In one embodiment, the structures able to be added to the digital twin include enclosures and/or windows for parts of or the whole of the car wash system. In one embodiment, the system incorporates dynamic lighting simulation of the car wash system based on the structures and on the internal light fixtures. Thereby, the platform is able to simulate the specific reach, intensity, and bounce of the lighting fixtures within the car wash system so as to determine the effect that the lighting routine is likely to have within the particular structure and to make adjustments accordingly. In one embodiment, the platform receives one or more inputs of one or more times of day for the routine, one or more geographic locations of the car wash system, one or more cloud cover conditions, one or more weather conditions, and/or one or more orientations of the car wash system, such that the dynamic lighting system is able to incorporate the position of the sun into the dynamic lighting parameters. For example, the dynamic lighting of the platform is able to determine the position and intensity of sunlight based on receiving an input of 50% cloud cover, at approximately 2 PM (or a range of times between noon and 5 PM) in a particular location, with the front of the car wash system oriented towards the North.

In one embodiment, the digital twin does not include dynamic lighting and is instead configured to provide a general plan view of the structure. In one embodiment, the dynamic lighting of the system is able to toggled on or off, and/or the dynamic lighting is only active during active simulations of the lighting routine. The ability to toggle dynamic lighting is useful, as it allows a clearer view of the components of the system during the placement stage, while providing for a more accurate simulation during a run of the routine.

In one embodiment, the page, or a separate fixture add page, is able to receive inputs to add a new type of fixture or structure. The platform is operable to receive input information regarding adjustable parameters of the fixture or structure. Furthermore, the platform is operable to automatically use an existing fixture or structure model or receive a CAD file (or other model file) to automatically important and construct a geometry for the fixture or structure. In one embodiment, the platform is operable to receive input resizing the fixture.

Examples of fixtures able to be dragged and dropped onto the digital twin include, but are not limited to, multicolor light bars, light emitting diode (LED) lights, flood lights, fluorescent lights, iridescent lights, light disks, differently shaped lighting elements, and/or any other type of lighting device. In one embodiment, one or more of the fixtures are able to be DMX-512 compliant lights (e.g., RGBW lights). In another embodiment, one or more of the fixtures are not DMX-512 compliant, with the platform providing particular value in being able to onboard existing lights into the system, rather than requiring all new lights be purchased.

Examples of structures able to be dragged and dropped onto the digital twin include, but are not limited to, arches, spraying nozzles, drying units, enclosures, and/or aesthetic elements (e.g., pillars, statues, etc.). In one embodiment, structures, such as arches, are static components that provide a closer visual emulation of the actual car wash system on the digital twin as a frame of reference for placing and manipulating the lighting fixtures and/or for informing dynamic lighting capabilities of the platform. In one embodiment, structures are able to include mobile components, and input is able to be received by the platform designating a pattern or speed of movements of the mobile components, allowing for timing or parameters of the fixtures to be dependent on the movement or position of the mobile components.

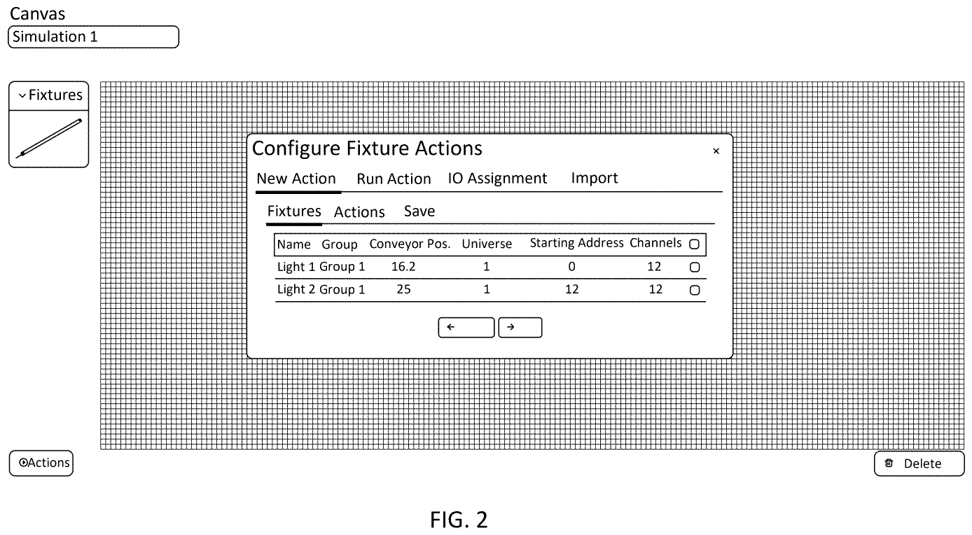

FIG. 2 illustrates a lighting configuration settings window of a GUI according to one embodiment of the present invention. In one embodiment, the digital twin simulation page includes a click-selectable button for editing actions and properties of the fixtures and/or structures constituting the digital twin. The lighting configuration settings window includes a list of fixtures in the digital twin, as well as properties, qualities, and/or organizational information for each fixture. For example, as shown in FIG. 2, in one embodiment, the list includes a name for each light, a group for each light, a position on the conveyor belt (or other structures) for each light, a universe for each light, a starting address for each light, a number of channels for each light, and/or other information. Additional information is able to include a size, one or more colors, and/or a timing or blinking pattern.

In one embodiment, fixtures are able to be assigned to different groups. Groups are useful, as they allow for uniform changes to be made across different lights, without specific settings needing to be made for each light, thereby saving the user time. Furthermore, by tying in different lights into groups and making changes to the routine at a group level, there is reduced risk that a user will make a change to some lights, but forget either to edit other similar fixtures, or forget the dependence of the routine of one fixture on the routine of another fixture. For example, if a user is developing a Halloween-themed routine and wishes to use an existing Christmas routine as a basis, the broad color scheme is able to be changed more when managed at the group level (i.e., all red lights able to be reassigned as orange lights, and all green lights reassigned as black/off lights). In one embodiment, groups are able to represent fixtures that perform actions that are strictly sequential based on actions of other fixtures in the group, or which occur simultaneously.

Furthermore, in one embodiment, fixtures are able to be assigned to different “universes.” According to different embodiments, universes are able to provide different functionality for the system to assist in broader management of lighting fixtures operated by a single user or group of users. In one embodiment, a single universe represents a single set of rules applicable to fixtures within that universe. For example, all lights in a single universe are able to have the same pattern or light colors applied, or have the same options able to be edited for each light. In another embodiment, universes represent distinct zones where the lights are operating. For example, a first universe represents the fixtures constituting an interior light routine for the car wash, while a second universe represents external lighting for the car wash. In this embodiment, different universes are also able to represent different car wash structures, or different lanes or housings of a single car wash.

Furthermore, in one embodiment, the list includes properties for each light, such as a number of channels for the lights, a starting address for each light, and/or a position of the light relative to the length of the car wash system.

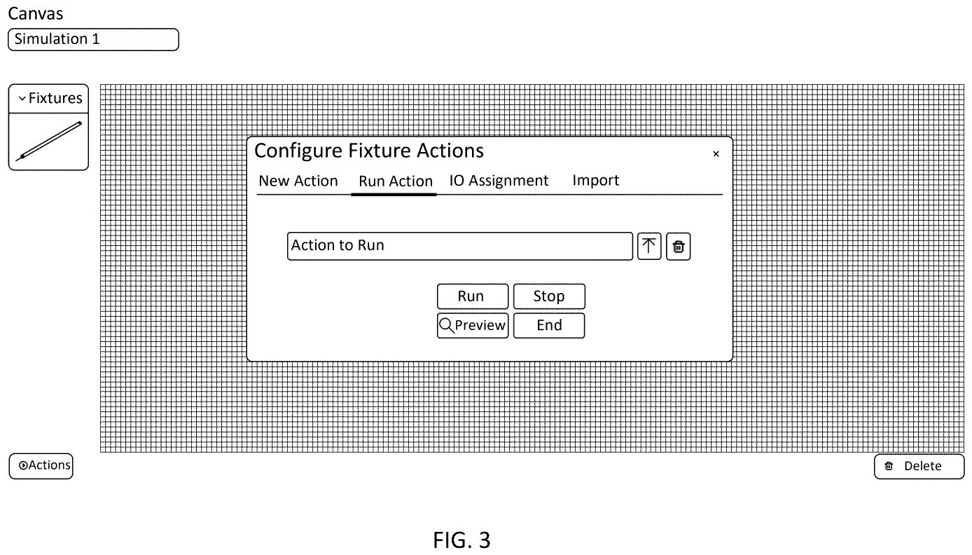

FIG. 3 illustrates an action run window of a GUI according to one embodiment of the present invention. The platform includes a window configured to receive inputs to run an action for the digital twin (e.g., begin a simulation of a lighting routine). In one embodiment, running a simulation of the lighting routine activates the digital twins of the lighting fixtures to display the programmed lighting colors and timing. In one embodiment, running the simulation also begins moving a virtual car along the car wash system at a programmed, or preset, rate. Furthermore, any other actions of the lighting routine, such as movement of structures, are also simulated in the digital twin. The action run window is able to receive an input to end or pause the simulation, and/or to edit the speed at which the simulation is run (e.g., at 2 times speed, 0.5 times speed, etc.). In one embodiment, the action run window is able to receive an input to begin and/or end a brief preview of the simulation.

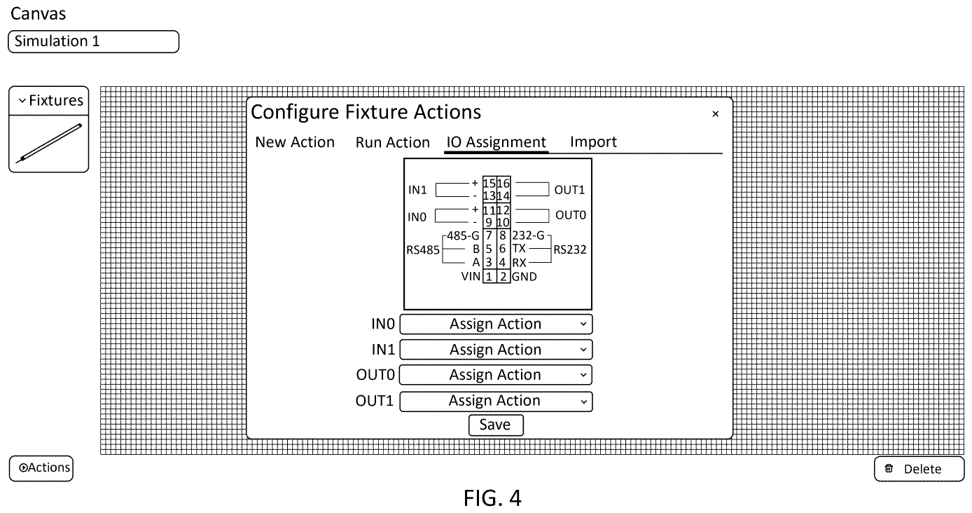

FIG. 4 illustrates an input-output configuration window of a GUI according to one embodiment of the present invention. In one embodiment, the GUI includes an input-output assignment tool for a controller connected to one or more fixtures and/or sensors operating in a particular lighting routine. Assigning fixtures to particular inputs and outputs allows the digital twin GUI environment to communicate with and operate through a command-and-control module of the platform to directly control a lighting control module. Additionally or alternatively, the platform transmits a routine, mapped to particular inputs and outputs to the lighting control module and the lighting control module independently executes that routine until it is updated by the platform with a different routine.

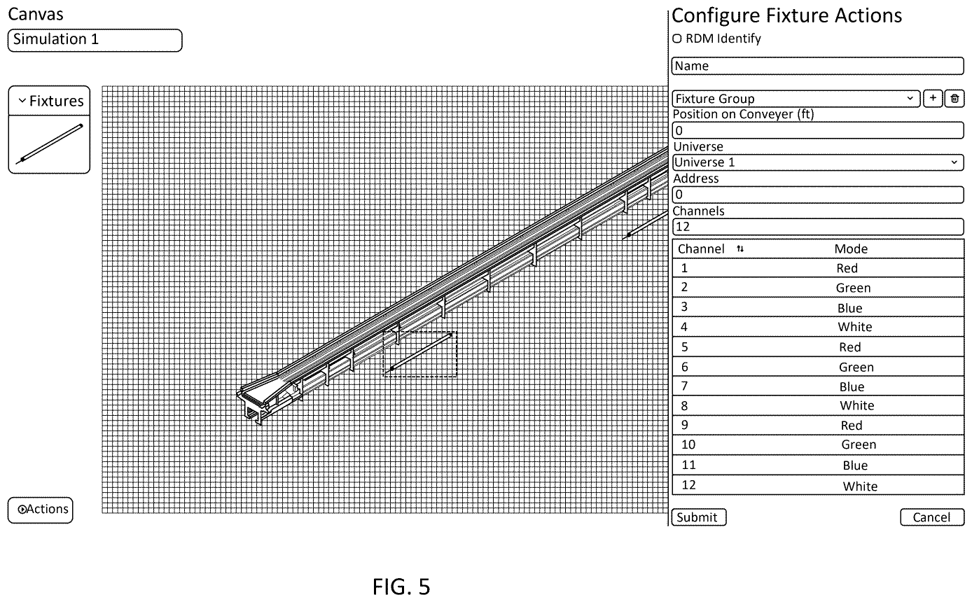

FIG. 5 illustrates a lighting device settings window of a GUI according to one embodiment of the present invention. In one embodiment, the lighting device settings window is able to receive selection of one or more fixtures and/or structures from a user device and generate a window or cabinet with fixture editing capabilities. The lighting device settings window is able to receive inputs to edit organization of the fixture, as it is able to receive input to change a name of the fixture, a grouping of the fixture, a position of the fixture relative to the length of the car wash system, a universe of the fixture, and/or an address of the fixture. In one embodiment, the lighting device settings window is able to receive an input to designate the fixture as subject to remote device management (RDM) or not. In one embodiment, the lighting device settings window is also able to receive inputs to edit physical properties of the fixture, such as a number of channels or a particular light or other component of the fixture or structure corresponding to each channel. This is especially useful, for example, where a user has custom edited a particular fixture or rearrange the lights or replace some of the lights with lights of different color or other qualities. In this situation, it is often not worth a user creating an entirely new fixture type, as a single fixture has those modifications. Therefore, instead of adding a new fixture type, the system provides for an ability to individually edit the fixture.

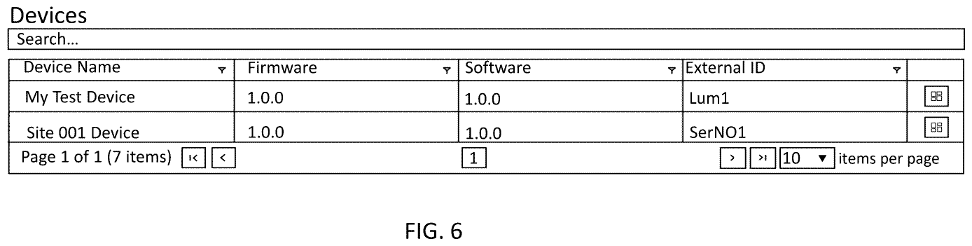

FIG. 6 illustrates a device management page of a GUI according to one embodiment of the present invention. In one embodiment, the platform includes a management page for each user profile, displaying car wash system routines created by and/or associated with a particular user profile. In one embodiment, the management page is presented as a table including listing for each system, along with columns for information regarding each system, including but not limited to a firmware version of the system, a software version of the system, an external identification (ID) code for the system, and/or other information. In one embodiment, the table is able to receive selection from a user device to cause the digital twin environment GUI for the selected system to load.

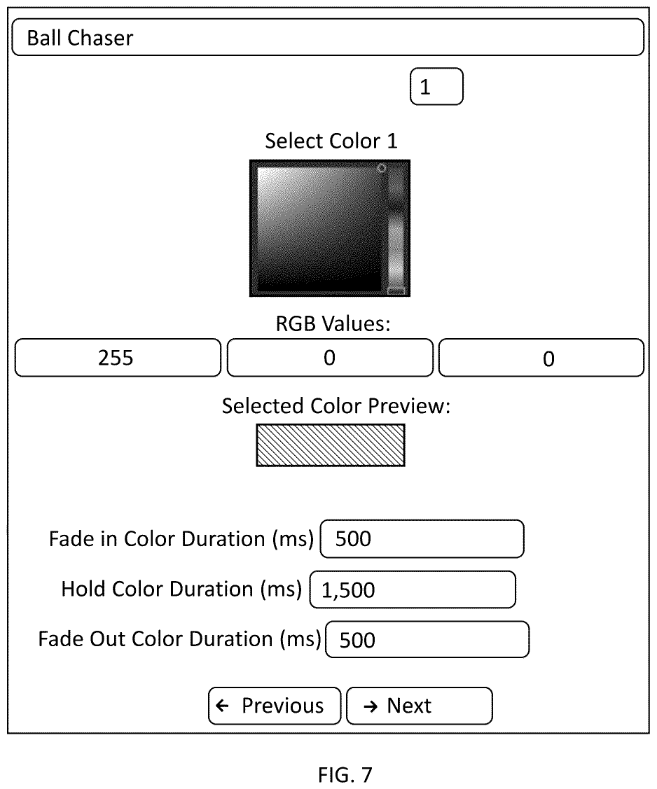

FIG. 7 illustrates an action configuration window of a GUI according to one embodiment of the present invention. In one embodiment, the platform is configured to receive selection of one or more existing action types or to create a new type of action to assign to one or more fixtures, or groups of fixtures. The assigned action determines functions carried out by the fixture over the course of a routine, such one or more particular display colors and/or light timings. The action configuration window is operable to accept a number of lights within the fixture to be programmed for the particular action, a color to display for one or more lights within the fixture, and/or timing information (e.g., fade in color duration, hold color duration, fade out color duration, etc.). In one embodiment, the action configuration window includes a color palette tool and is operable to accept click selection of a color to assign to one or more of the lights. In one embodiment, the action configuration window is operable to display a preview of the selected color. In one embodiment, the action configuration window is configured to accept text inputs of RGB values to define the color of the light. One of ordinary skill in the art will understand that the fields in which user device input are accepted in the action configuration window are able to vary depending on the particular variable parameters of the action type being created or modified. For example, in one embodiment, color selection and/or timing section is not a part of a particular action configuration window. In another embodiment, the action configuration window is configured to receive additional information, other than color selection and/or timing parameters.

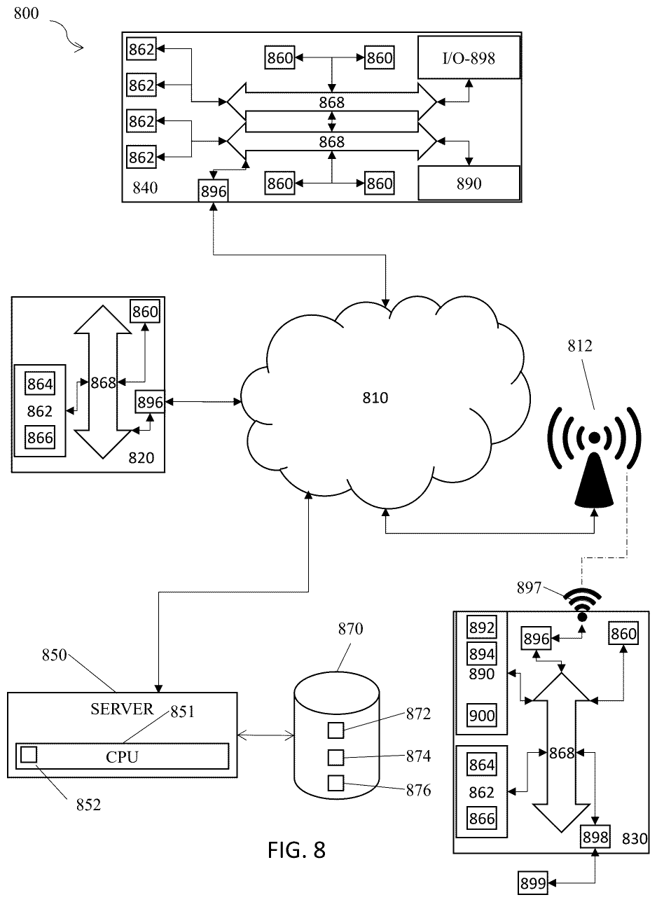

FIG. 8 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 8, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable to be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 8, is operable to include other components that are not explicitly shown in FIG. 8, or is operable to utilize an architecture completely different than that shown in FIG. 8. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for managing dynamic lighting for a car wash, comprising:
a server platform, including a processor and a memory; and
a graphical user interface (GUI) generated on a user device in network communication with the server platform;
wherein the GUI includes a digital twin of a car wash system; and
wherein the GUI is configured to receive drag and drop selection of one or more digital twins of programmable light elements on the car wash system.

2. The system of claim 1, wherein the one or more digital twins are automatically snapped to one or more preexisting elements of the digital twin of the car wash system.

3. The system of claim 1, wherein the system receives selection of one or more settings of the car wash system as a whole.

4. The system of claim 1, wherein the programmable light elements include DMX512-configured elements.

5. The system of claim 1, wherein the server platform receives one or more computer aided design (CAD) files and automatically generates the one or more digital twins based on the one or more CAD files.

6. The system of claim 1, wherein the system receives selection of one or more external lighting or weather conditions.

7. The system of claim 1, wherein the GUI is operable to generate a simulation of a dynamic lighting routine.

8. The system of claim 7, wherein the GUI receives selection of a speed at which to run the simulation of the dynamic lighting routine.

9. A method for managing dynamic lighting for a car wash, comprising:
providing a server platform, including a processor and a memory; and
generating a graphical user interface (GUI) on a user device in network communication with the server platform;
the GUI displaying a digital twin of a car wash system; and
the GUI receiving drag and drop selection of one or more digital twins of programmable light elements on the car wash system.

10. The method of claim 9, further comprising the one or more digital twins automatically snapping to one or more preexisting elements of the digital twin of the car wash system.

11. The method of claim 9, further comprising the system receiving selection of one or more settings of the car wash system as a whole.

12. The method of claim 9, wherein the programmable light elements include DMX512-configured elements.

13. The method of claim 9, further comprising the server platform receiving one or more computer aided design (CAD) files and automatically generating the one or more digital twins based on the one or more CAD files.

14. The method of claim 9, further comprising the system receiving selection of one or more external lighting or weather conditions.

15. The method of claim 9, further comprising the GUI generating a simulation of a dynamic lighting routine.

16. The method of claim 15, further comprising the GUI receiving selection of a speed at which to run the simulation of the dynamic lighting routine.

17. A system for managing dynamic lighting for a car wash, comprising:
a server platform, including a processor and a memory; and
a graphical user interface (GUI) generated on a user device in network communication with the server platform;
wherein the GUI includes a digital twin of a car wash system;
wherein the GUI is configured to receive selection of settings for one or more digital twins of programmable light elements on the car wash system; and
wherein actual light elements corresponding to the one or more digital twins are automatically programmed in accordance with the selection of the settings.

18. The system of claim 17, wherein the system receives selection of one or more settings of the car wash system as a whole.

19. The system of claim 17, wherein the programmable light elements include DMX512-configured elements.

20. The system of claim 17, wherein the server platform receives one or more computer aided design (CAD) files and automatically generates the one or more digital twins based on the one or more CAD files.
